(19) United States
(12) Patent Application Publication
(10) Pub. No.: US 2024/0419728 A1
(43) Pub. Date: Dec. 19, 2024

(54) Music And Radio Programming Recommendations Based on Over-The-Air Radio Broadcast Listening

(71) Applicant: iBiquity Digital Corporation, Columbia, MD (US)

(72) Inventors: Paul Venezia, Keene, NH (US); Robert M. Dillon, Mendham, NJ (US); Christopher Ambrozic, Chapel Hill, NC (US); Allen Schrott, Ann Arbor, MI (US)

(21) Appl. No.: 18/745,486

(22) Filed: Jun. 17, 2024

Related U.S. Application Data
(60) Provisional application No. 63/508,448, filed on Jun. 15, 2023.

(51) Int. Cl. G06F 16/635; G06F 16/68; H04H 60/47

(52) U.S. Cl. CPC G06F 16/635; G06F 16/686; H04H 60/47

(57) ABSTRACT

Generally disclosed herein is a mechanism to provide music and radio station recommendations based on observing radio and music listening activities of a user over time. In some examples, information about the radio stations receivable by a user device and programs broadcast by such radio stations are collected over time. Recommendations for different music and/or radio stations may be generated based on a single song or radio program that the user listens to. The recommended music and/or radio stations may be updated based on program information related to the radio stations receivable by the user device at a specific time at a specific geographic location.

### CROSS-REFERENCE TO RELATED APPLICATIONS

This application claims the benefit of the filing date of U.S. Provisional Patent Application No. 63/508,448 filed Jun. 15, 2023, the disclosure of which is hereby incorporated herein by reference.

### BACKGROUND

Over-the-air (OTA) radio broadcast signals can be used to deliver a variety of programming content to radio receiver systems. Over-the-air radio broadcast signals include conventional amplitude modulated (AM) and frequency modulated (FM) analog broadcast signals, digital radio broadcast signals, or other broadcast signals. Digital radio broadcast signals can deliver digital audio and data services to the radio receiver systems. Users may tune the radio receivers to a variety of radio stations, including analog and digital broadcasts, for particular radio programs or music.

Typically, each radio station broadcasts a different radio program at different times, with each program focusing on a particular genre of music or category of subject matter for talk radio. Many users prefer listening to a particular genre of music at particular times during the day. For example, a user may like to listen to jazz music when driving to the user's workplace on Monday morning. However, as a result of the number of programs available across various radio stations and a varying list of the radio stations receivable at different geographic locations, it can be difficult for the user to find and access stations playing the type of programs the user prefers at the times when the user would like to listen.

### BRIEF SUMMARY

Generally disclosed herein is a mechanism to provide music and radio station recommendations based on observing radio and music listening activities of a user over a particular period. In some examples, information about the radio stations receivable by a user device and programs broadcast by such radio stations are collected over time. Recommendations for different music and/or radio stations may be generated based on a single song or radio program that the user listens to. The recommended music and/or radio stations may be updated based on program information related to the radio stations receivable by the user device at a specific time at a specific geographic location.

An aspect of the disclosure provides a system for generating recommendations for receivable over-the-air audio content. The system comprises one or more memories, and one or more processors in communication with the one or more memories, the one or more processors configured to determine one or more radio stations receivable by a user device, detect a user listening activity, identify information related to first audio content broadcast by a first radio station during the detected user listening activity, identify program information related to the one or more radio stations receivable by the user device, generate a recommendation based on the identified information related to the first audio content broadcast by the first radio station and the identified program information related to the one or more radio stations receivable by the user device, and output the generated recommendation to the user device.

In an example, the user listening activity includes tuning the user device to a first broadcast channel for the first radio station or remaining on the first broadcast channel for a threshold time period.

In another example, the one or more processors are further configured to retrieve metadata of the first audio content from a database and transmit the metadata to the user device, wherein the metadata includes information related to an artist, composer, published date, or genre.

In yet another example, the one or more processors are further configured to determine preference data or historical data for the user based on one or more previous listening activities for the user, and generate the recommendation based on the determined user's preference data or historical data.

In yet another example, generating the recommendation comprises generating a recommendation for a second radio station based on the first radio station that the user accessed during the detected user listening activity.

In yet another example, generating the recommendation comprises generating a recommendation for second audio content broadcast by a second radio station based on program information related to the first radio station that the user accessed during the detected user listening activity.

In yet another example, generating the recommendation comprises generating a recommendation for a second radio station from the determined one or more radio stations receivable to the user device based on the identified information related to the first audio content broadcast from the first radio station during the detected user listening activity.

In yet another example, the one or more processors are further configured to receive a request from the user for a customized recommendation using the user device.

In yet another example, the one or more processors are further configured to receive feedback on the generated recommendation and update the recommendation based on the received feedback using the user device.

In yet another example, the recommendation is generated specific to a time, day, or week based on available programs of the one or more radio stations receivable by the user device.

Another aspect of the disclosure provides a method for generating recommendations for receivable over-the-air audio content. The method comprises determining one or more radio stations receivable by a user device, detecting a user listening activity, identifying information related to first audio content broadcast by a first radio station during the detected user listening activity, identifying program information related to the one or more radio stations receivable by the user device, generating a recommendation based on the identified information related to the first audio content broadcast by the first radio station and the identified program information related to the one or more radio stations receivable by the user device, and outputting the generated recommendation to the user device.

In an example, the user listening activity includes tuning the user device to a first broadcast channel for the first radio station or remaining on the first broadcast channel for a threshold time period.

In another example, the method further comprises retrieving metadata of the first audio content from a database and transmitting the metadata to the user device, wherein the metadata includes information related to an artist, composer, published date, or genre.

In yet another example, the method further comprises determining preference data or historical data for a user based on one or more previous listening activities for the user, and generating the recommendation based on the determined user's preference data or historical data.

In yet another example, generating the recommendation comprises generating a recommendation for a second radio station based on the first radio station that the user accessed during the detected user listening activity.

In yet another example, generating the recommendation comprises generating a recommendation for second audio content broadcast by a second radio station based on program information related to the first radio station that the user accessed during the detected user listening activity.

In yet another example, generating the recommendation comprises generating a recommendation for a second radio station from the determined one or more radio stations receivable by the user device based on the identified information related to the first audio content broadcast from the first radio station during the detected user listening activity.

In yet another example, the method further comprises receiving a request from the user for a customized recommendation using the user device.

In yet another example, the method further comprises receiving feedback on the generated recommendation and updating the recommendation based on the received feedback using the user device.

Yet another aspect of the disclosure provides a non-transitory computer-readable medium storing instructions executable by one or more processors for performing a method of generating recommendations for receivable over-the-air broadcast content. The method comprises determining one or more radio stations receivable by a user device, detecting a user listening activity, identifying information related to first audio content broadcast by a first radio station during the detected user listening activity, identifying program information related to the one or more radio stations receivable by the user device, generating a recommendation based on the identified information related to the first audio content broadcast by the first radio station and the identified program information related to the one or more radio stations receivable by the user device, and outputting the generated recommendation to the user device.

### BRIEF DESCRIPTION OF THE DRAWINGS

FIG. 1 depicts diagrams illustrating an example system for providing music and radio programming recommendations associated with over-the-air radio broadcast signals according to aspects of the disclosure.

FIG. 2 depicts a block diagram illustrating example components of music and radio programming recommendation system according to aspects of the disclosure.

FIG. 3 depicts a block diagram illustrating an example radio receiver according to aspects of the disclosure.

FIG. 4 depicts a block diagram illustrating an example server system according to aspects of the disclosure.

FIG. 5 depicts a flow diagram illustrating an example music and radio programming recommendation process according to aspects of the disclosure.

### DETAILED DESCRIPTION

The present disclosure provides a system and method for automatically recommending radio stations, radio programs, and/or music based on analyzing the user's listening activities and program information associated with programs receivable by the user device at certain times at certain geographic locations. The user's preferences for particular types of music, artists, or genres can be identified based on monitoring the user's listening activities over a given period of time. Based on the time and day when the user's listening activities occurred, time-specific recommendations for genres of music or radio stations can be output on the user device, such as visual output through a display, audible output through a speaker, etc.

The system may collect data related to the programs or music that radio stations broadcast on certain days at certain times. Since each radio station may produce different programs and change the programs unbeknownst to the user, the system may monitor any changes in the schedule and the content of programs that each radio station produces and broadcasts. The system may also monitor the program content produced and broadcast by each of the plurality of radio stations receivable by the user device at a particular geographic location.

In some examples, camera systems can monitor the user's facial expressions and/or body movements while the user is listening to a particular song or station. Based on the user's facial expressions and/or body movements, the system can determine the user's moods or emotions while listening to the particular song or station.

In some examples, the system may monitor the changes in the audio volumes controlled by the user. Based on the changes in volume, the system can infer the user's affinities or interests in particular programs or music that a particular radio station broadcasts. For example, if the user adjusts the volume controls to increase the volume while a particular song is being received through the user's OTA receiver, the system may infer that the user enjoys the particular song. In response, the system can update a profile of the user to reflect the user's preference for the particular song.

In some examples, the system may use a machine learning model trained with data related to other users who share interests in similar types of music or artists. The system may use the machine learning model to predict what other radio stations or music the user may enjoy listening to. The machine learning model may be refined using feedback received from the user device.

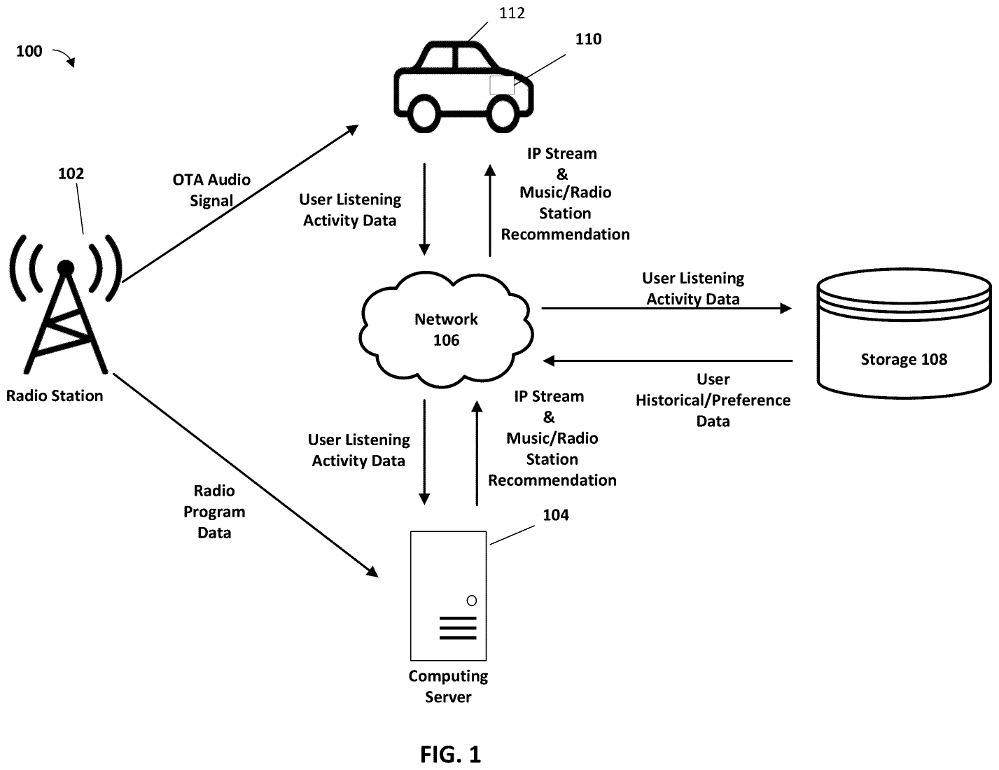

FIG. 1 depicts a block diagram illustrating an example system for providing music and radio programming recommendations associated with over-the-air radio broadcast signals. The music and radio programming recommendations system 100 generates recommendations for content available from radio station 102 based on listening preferences of the user. While one radio station 102 is shown, it should be understood that multiple radio stations can broadcast audio to any number of user listening devices, and that user listening activity for a first radio station may be used to generate recommendations for content available from one or more radio stations. Computing server 104 may continually identify a list of radio stations receivable by radio receiver 110 based on the location of radio receiver 110 and receive the program information associated with the content available from each of the radio stations receivable by radio receiver 110.

The music and radio programming recommendations system 100 may include computing servers 104 and storage 108. Radio station 102 may transmit an OTA audio signal to radio receiver 110. Radio station 102 may send radio program data to computer servers 104. Radio receivers 110 may send user listening activity data to computing servers 104 via network 105. User listening activity data may include data related to the radio station that the radio receiver 110 is tuned to, radio content that the user is currently listening to, timestamp data recorded when the user is listening to particular radio content, location data where the user is listening, etc. The user listening activity data may also include information as to whether the user is tuning the user device to a particular broadcast channel for a particular radio station or remaining on the broadcast channel for a threshold time period. Radio receiver 110 may receive music and/or radio station recommendations from computing server 104 via network 105. Such listening activity data can be stored in storage 108 via network 106. Computing servers 104 can receive user historical or preference data from storage 108 and use such data to generate music or radio station recommendations, which are provided to the radio receiver 110.

Radio station 102 may include traditional broadcast radio stations or any type of radio transmitter system that can transmit an OTA audio signal. The OTA audio signal may include an analog audio signal, a digital audio signal, or a hybrid audio signal.

Radio receiver 110 may include a tuner that can tune into a radio station. Radio receiver 110 may receive the OTA audio signal from radio station 102. Radio receiver 110 may also receive IP-delivered content from computing server 104. The IP-delivered content may include dynamic metadata such as information related to artists, song titles, on-air radio program information, and station content information.

Radio receiver 110 may be a hand-held device such as a tablet, laptop, smartphone, or smart wearable that includes hardware and/or software for implementing both receiving IP-delivered content via wireless IP and a radio receiver comprising radio chipset and associated antenna systems. Radio receiver 110 may be included in a vehicle 112 or may include a smartphone that can receive the IP-delivered content. The smartphone may be physically, or wirelessly linked to the vehicle 112. Radio receiver 110 may also transmit user listening activity data to computing server 104 via network 106. Radio receiver 110 may send the user listening activity data via network 106 to storage 108.

Computing server 104 may receive and analyze the radio program data from radio station 102. The radio program data may include information about the programs of radio station 102. Such information may include data about the songs, music, artists, programs, and any types of content that radio station 102 produces and broadcasts. Computing server 104 may receive radio program data from a plurality of radio stations even though FIG. 1 depicts a single radio station for the illustration purposes. Computing server 104 may determine specific time windows when radio station 102 broadcasts a particular program. For example, computing server 104 may determine when a classical music station broadcasts a jazz program on a particular day of the week at a particular time. Computing server 104 may recommend the above radio station to the user who likes to listen to jazz music only at the above-mentioned particular time.

Computing server 104 may transmit IP stream to receiver 110. The IP stream may include the IP-delivered content such as dynamic metadata such as artistic information, song titles, on-air radio program information, and station content information associated with radio station 102 or static metadata such as slogan, logo, and name of radio station 102. IP stream may also include access information associated with the radio streaming service that radio station 102 may provide over the Internet. For example, the user may tune radio receiver 110 into radio station 102 and receive IP streaming information from computing server 104 via a link or QR code shown on a display of radio receiver 110 such that the user may later access particular radio content that radio station 102 broadcasts through Internet streaming using the user's smartphone, laptop or smartwatch.

Computing server 104 may receive the user's current listening activity data directly from radio receiver 110 via network 106. Computing server 104 may store the current listening activity data as the user's historical or preference data in storage 108 for future use. Computing server 104 may retrieve the user historical or preference data from storage 108 via network 106. Computing server 104 may determine other music or radio stations that the user may enjoy based on the analysis of the user's historical or preference data and the current user listening activity data. In some examples, computing server 104 may retrieve other users' historical or preference data when the other user's profile information is determined to be similar to the current user's profile information. The user's profile information may include the user's geographic information, age, gender, ethnicity, date of birth, and the music, radio programs, or other radio content that the user routinely listens to. Computing server 104 may determine similar music or radio stations from storage 108 based on a comparison of the user's historical or preference data and the information related to the user's current listening activity. In some examples, computing server 104 may generate a customized music or radio station recommendation based on the information about a single song the user is currently listening to. Computing server 104 may generate a customized music or radio station recommendation based on the radio station the user routinely tunes into or used to tune into in the past. In another example, computing server 104 may generate a list of recommended radio stations that broadcast music played by the artist the user likes. Computing server 104 may determine that the user would enjoy listening to other music played or composed by the same artists. For example, if a user enjoys listening to rock music from the 1970s, computing server 104 may generate a list of radio stations that may play other rock music from the 1970s. Computing server 104 may determine whether a user who likes to listen to rock music from the 1970s may be interested in listening to crossover music such as jazz-rock or fusion.

Computing server 104 may utilize a machine learning model trained with a variety of music listening activity data from a plurality of users. Computing server 104 may retrain the machine learning model with any feedback data provided by the user and refine the list of recommended music or radio stations for future use.

Computing server 104 may provide the list of radio stations receivable by radio receiver 110. For example, the computer server 104 may provide information to the receiver indicating which radio stations are broadcasting signals at a given time in range of receiver 110. In some examples, the receiver can then provide to the computing server 104 information related to quality, such as a measurement of how clearly a station can be received by the receiver, or how much noise or static or interference is included in broadcast signals from the station, or that a signal is receivable at all. In this regard, the receiver 110 can report only receivable stations that can be received at or above a threshold quality level, or the receiver 110 may filter out stations sent by the computing server 104 that fall below a threshold quality level. As another example, computing server 104 may receive radio receiver 110's latitude and longitude information using an API. The latitude or longitude information may include city, state, ZIP code, or other means of geographic identification that may be used by computer server 104 to identify radio stations receivable by radio receiver 110.

If the user drives to a different town or state, radio receiver 110 may receive OTA audio signals from different radio stations. Computing server 104 may determine the receivable radio stations continually, and therefore may detect an updated set of receivable radio stations if the user device is moving (e.g., in a vehicle) out of a first reception zone and into a second reception zone. Moreover, computing server may continually receive the respective radio program data from each radio station in the respective reception zones. Accordingly, as vehicle 112 travels, updated recommendations may be generated and provided to the user in real-time, near real-time, or at pre-configured time intervals.

In some examples, computing server 104 may use a machine learning model to predict the radio stations or programs available in the user's location and interesting to the user based on the user's preference data. For example, if the user routinely drives from New York to Connecticut three days a week, computing server 104 may automatically select the radio stations and the associated programs for the times that the machine learning model predicts the user will be in Connecticut and vice versa.

In other examples, computing server 104 may communicate with the global positioning system (GPS) and predict using the machine learning model when the user will be in a particular geographic location at a specific time and generate recommendations for available radio stations and the associated programs for the above time in the particular geographic location.

Computing server 104 may determine an appropriate time to send the generated music or radio station recommendations to radio receiver 110. For example, computing server 104 may determine that the user routinely listens to classical music while commuting to work at 7 am. Computing server 104 may send a recommended list of radio stations shortly before 7 am. Alternatively, computing server 104 may send the notification to the user's smartphone or smartwatch. In the example of rock music from the 1970s, computing server 104 may send the recommendation for the radio stations and the scheduled broadcast time for rock music from the 1970s several times throughout the day.

Computing server 104 may send the recommendation to a display screen equipped in vehicle 112 and allow the user to interact with the display screen. For example, the user may select or deselect one or more recommended radio stations from the display screen to accept or decline. Any interaction or feedback input by the user may be stored in storage 108. Computing server 104 may use the stored input data as the user's historical or preference data.

According to some examples, computing server 104 may analyze the user's mood to generate the music or radio station recommendation. User's vehicle 112 may be equipped with one or more camera sensors configured to monitor the face of the user while driving and may send the facial expression information to computing server 104 for analysis. Computing server 104 may utilize a machine learning model to determine the music that matches the user's mood.

In other examples, computing server 104 may receive biometric information about the user such as heart rate or temperatures measured by the user's wearable devices and determine the user's mood or emotions. Computing server 104 may also analyze the received biometric information to determine whether the user is enjoying the music or radio program currently being played.

Computing server 104 may also communicate with a speaker or microphone system equipped in vehicle 112 and collect the audio information from the user. Such audio information may include the user's voice captured when the user is singing or humming to particular songs, or the user is shouting or yelling when listening to a particular radio program.

Computing server 104 may receive the above information from a group of individuals sitting in vehicle 112 collectively. For example, if one or more individuals in vehicle 112 sign along to a particular song with loud voices, computing server 104 may determine that the group is interested in such a particular song and recommend similar songs for the group.

In other examples, computing server 104 may be communicably coupled to a display screen, sound controller, or music player equipped in vehicle 112. Computing server 104 may detect a change in volumes controlled by the user in vehicle 112 to determine whether the user is trying to listen carefully to a particular song or music. If the user turns on the volume of the music composed by a particular artist, computing server 104 may determine that the user would be interested in other music composed or played by the same artist.

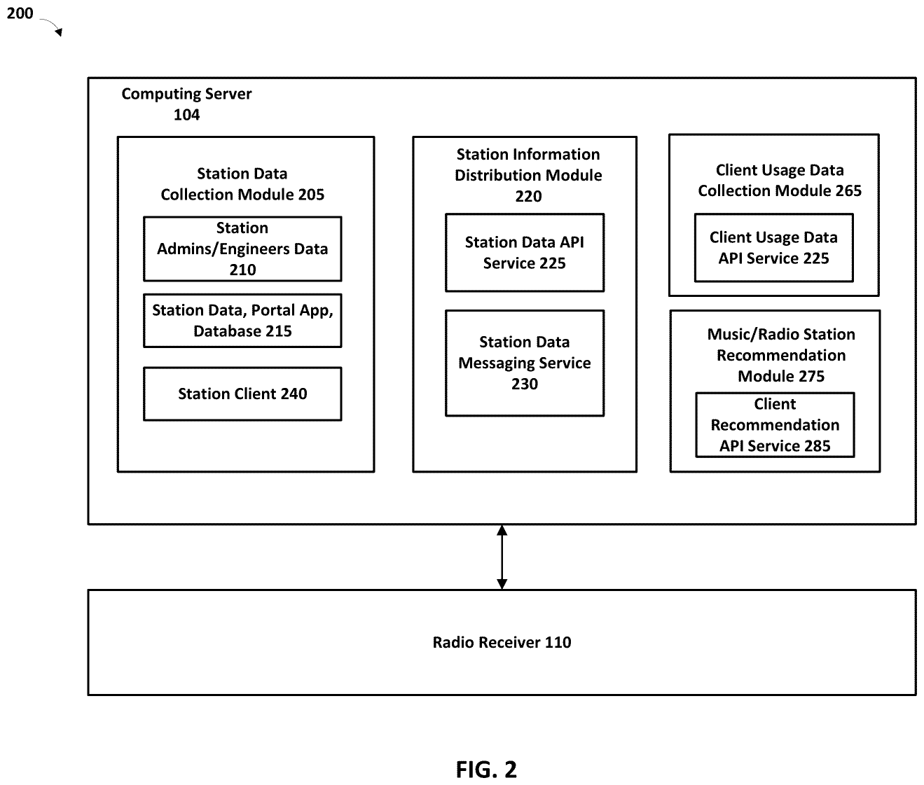

FIG. 2 depicts a block diagram illustrating example components of music and radio programming recommendation system. Computing server 104 may comprise station data collection module 205, station information distribution module 220, client usage data collection module 265, and music or radio station recommendation module 275. Computing server 104 may communicate with radio receiver 110 to receive user listening activity data and send music or radio station recommendation as described in connection with FIG. 1. Station data collection module 205 may include station admin or engineer data 210, station data, portal app and database 214 and station client 240. Station information distribution module 220 may comprise station data API service 225 and station data messaging service 230. Client usage data collection module 265 may include client usage data API service 225. Music or radio station recommendation module 275 may include client recommendation API service 285.

Station data collection module 205 may be configured to keep track of what is being played by each of multiple radio stations via an API. Station data collection module 205 may collect various identification information that can describe a particular radio station from station admin or engineer data 210. Station admin or engineer data 210 may include various information about the radio station such as logo, slogan, themes or genres of music that the radio station broadcasts. The above identification may be stored in station data, portal app database 215. Station client 240 may include detailed information about music, associated artists, schedules of each radio program, etc.

Station information distribution module 220 may be configured to transmit radio station data to radio receiver 110 via station data API service 225. Station data API service 25 may provide the radio station data, and associated metadata, music, and program information of each radio station stored in station data, portal app, database 215 to radio receiver 110. Station data messaging service 230 may provide information as to whether the radio station has a new radio program or has changed the genre of the music that the respective radio station routinely broadcasts, etc., such that the user can be notified of such changes on a display screen of radio receiver 110.

Client usage data collection module 265 may be configured to collect client usage data via client usage data API service 225. Client usage data may include information related to the identification of the radio station, and its radio program or music that the user is currently listening to. Client usage data may include the historical usage data related to the user's past listening activities. Client usage data API service 225 may also keep track of the altitude or longitude information of radio receiver 110 to identify any available radio coverage in the vicinity.

Music or radio station recommendation module 275 may be configured to send music or radio station recommendations using client recommendation API service 285. Client recommendation API service 285 may be capable of communicating with radio station 102 via wireless IP. Client recommendation API service 285 may also directly communicate with radio receiver 110 via wireless IP. Client recommendation API service 285 may change the recommendations as the client usage data received by client usage data collection module 265 changes. For example, if the user tunes radio receiver 110 to a different station that broadcasts different genres of music, client recommendation API service 285 may update the recommendation and send the updated recommendation to radio receiver 110 in real-time or near real-time.

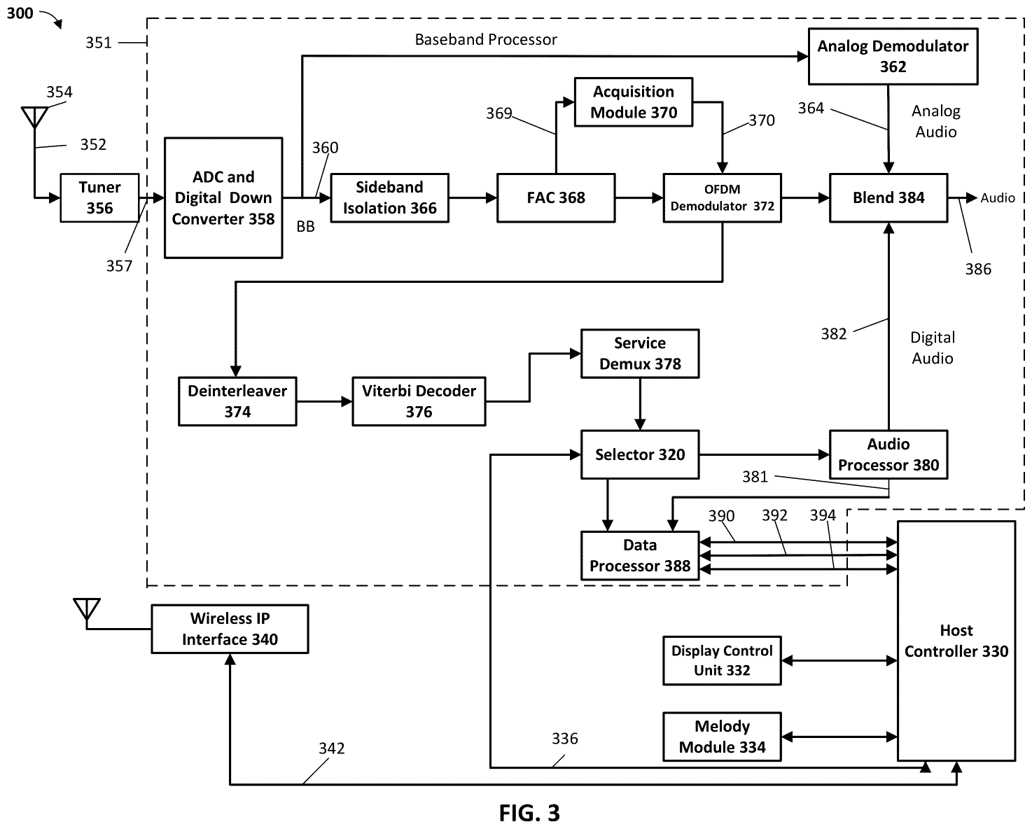

FIG. 3 depicts a block diagram illustrating an example radio receiver 300. In some examples, radio receiver 300 may be an in-band on-channel (IBOC) digital radio receiver. An IBOC implementation of digital radio broadcasting and reception is described in U.S. Pat. No. 8,676,114, which is incorporated herein by reference in its entirety. To implement the approaches of the instant disclosure, radio receiver 300 includes a wireless IP interface 340 for music or radio station recommendations via wireless IP and other components for receiving over-the-air radio broadcast signals. The wireless IP interface 340 and host controller 330 may be collectively referred to as a wireless internet protocol hardware communication module.

It should be understood that radio receiver 300 of FIG. 3 is merely an example. In some examples, radio receiver 300 may be equivalent to radio receiver 110 as depicted in FIG. 1. In other examples, the radio broadcast receiver system 110 depicted in FIG. 1 does not use radio receiver 300 of FIG. 3 and instead uses other hardware and/or software for implementing both an Internet receiver and a radio receiver.

While only certain components of radio receiver 300 are shown for exemplary purposes, it should be apparent that the receiver may comprise a number of additional components. The additional components may be distributed among a number of separate enclosures having tuners and front-ends, speakers, remote controls, various input/output devices, and other components. The exemplary receiver includes a tuner 356 that has an input 352 connected to an antenna 354. Antenna 354, tuner 356, and baseband processor 351 may be collectively referred to as an over-the-air radio broadcast hardware communication module.

Within the baseband processor 351, the intermediate frequency signal 357 from the tuner 356 is provided to an analog-to-digital converter and digital down converter 358 to produce a baseband signal at output 360 comprising a series of complex signal samples. The signal samples are complex in that each sample comprises a “real” component and an “imaginary” component. An analog demodulator 362 demodulates the analog modulated portion of the baseband signal to produce an analog audio signal on line 364. The digitally modulated portion of the sampled baseband signal is next filtered by sideband isolation filter 366, which has a passband frequency response comprising the collective set of subcarriers f1-fn present in the received orthogonal frequency-division multiplexing (OFDM) signal. First adjacent canceller (FAC) 368 suppresses the effects of a first-adjacent interferer. Complex signal 369 is routed to the input of acquisition module 370, which acquires or recovers OFDM symbol timing offset/error and carrier frequency offset/error from the received OFDM symbols as represented in received complex signal 369. Acquisition module 370 develops a symbol timing offset At and carrier frequency offset Δf, as well as status and control information. The signal is then demodulated (block 372) to demodulate the digitally modulated portion of the baseband signal.

Then the digital signal is de-interleaved by a de-interleaver 374 and decoded by a Viterbi decoder 376. Viterbi decoder 376 may include any decoder that uses the Viterbi algorithm for decoding a bitstream that includes convolution codes. A service de-multiplexer 378 separates main and supplemental program signals from data signals.

The example radio receiver 300 of FIG. 3 also includes a wireless IP interface 340 for receiving data via wireless Internet. The wireless IP interface 340 is managed by the host controller 330. As illustrated in FIG. 3, the wireless IP interface 340 and the host controller 330 are coupled via line 342, and data transmitted between the wireless IP interface 340 and the host controller 330 is sent over line 342. A component may select data received via the wireless IP interface 340 for rendering. For example, selector 320 may connect to host controller 330 via line 336 to select specific data received from the wireless IP interface 340.

The data for rendering may include music or radio station recommendations, as described herein, and may be rendered at substantially the same time that primary programming content received over-the-air (e.g., audio received via an over-the-air radio broadcast signal) is rendered.

In some examples, a component (e.g., the selector 320) of the receiver 300 may make a request to a file server for recommendations for similar music or receivable radio stations that broadcast similar music, e.g., via the wireless IP interface 340, which communicates with the host controller 330, to send a request for the recommendations. An audio processor 380 processes received signals to produce an audio signal on line 382 and MPSD/SPSD 381. In some examples, analog and main digital audio signals are blended as shown in block 384, or the supplemental program signal is passed through, to produce an audio output on line 386. A data processor 388 processes received data signals and produces data output signals on lines 390, 392, and 394. The data lines 390, 392, and 394 may be multiplexed together onto a suitable bus such as an I2c, SPI, UART, or USB. The data signals can include, for example, data representing the recommendations to be rendered at the receiver.

The host controller 330 receives and processes the data signals. The host controller 330 comprises a microcontroller that is coupled to the display control unit (DCU) 332 and memory module 334. Any suitable microcontroller could be used such as an 8-bit RISC microcontroller, an advanced RISC machine 32-bit microcontroller, or any other suitable microcontroller. Additionally, a portion or all of the functions of the host controller 330 could be performed in a baseband processor (e.g., the processor 380 and/or data processor 388). The DCU 332 comprises any suitable input/output (I/O) processor that controls the display, which may be any suitable visual display such as an LCD or LED display. In certain examples, the DCU 332 may also control user input components via a touch-screen display. In some examples, DCU 332 may be configured to allow the user to accept or decline one or more music or radio stations recommended by computing server 104 of FIG. 1. In other examples, the host controller 330 may also control user input from a keyboard, dials, knobs, or other suitable inputs. The memory module 334 may include any suitable data storage medium such as RAM, Flash ROM (e.g., an SD memory card), and/or a hard disk drive. In some examples, the memory module 334 may be included in an external component that communicates with the host controller 330 such as a remote control.

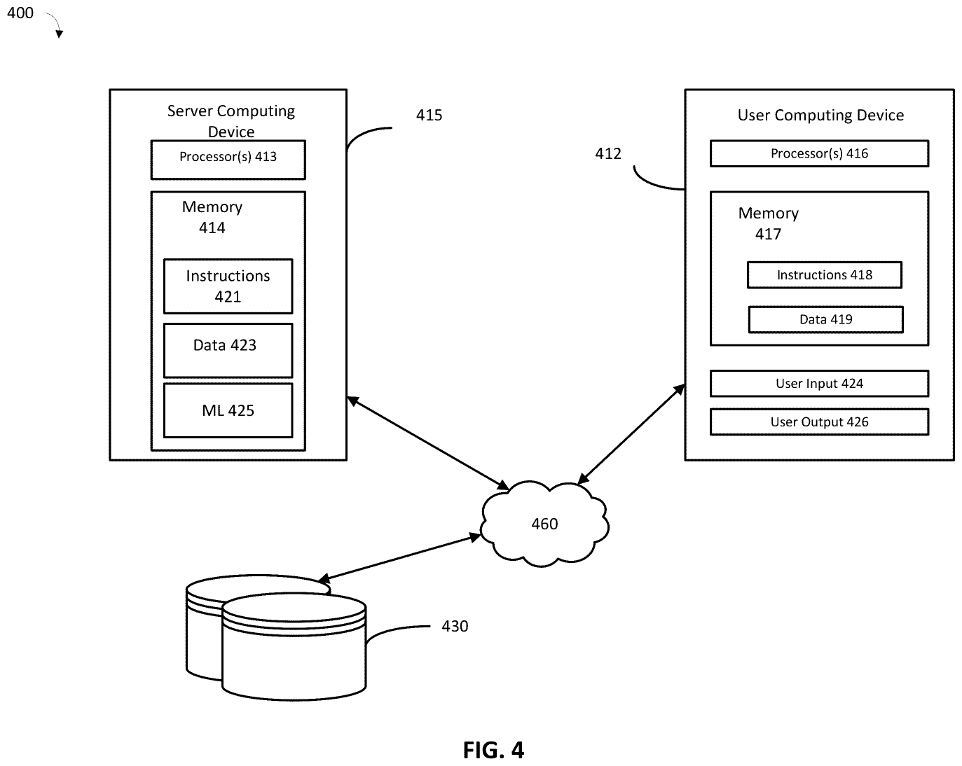

FIG. 4 depicts a block diagram illustrating example components of a server system. User computing device 412 may include a radio receiver with a display that can be adapted to display recommended radio stations or music. Server computing device 415 may be a component of computing server 104 illustrated in FIG. 1. Server computing device 415 may provide music or radio station recommendations to the user computing device 412 for display. Server computing device 415 may further receive and analyze the information related to the user listening activities. For example, the information related to the user listening activities includes information as to music or radio programs that the user listens to for a particular period of time. In some examples, the information may also include the geographic location of the user device. User computing device 412 may transmit a request from the user to server computing device 415 for music or radio station recommendations based on the user's preferred artists, genre of music and/or particular time of the day for listening. The music or radio station recommendations may be displayed on a display of user computing device 412, or otherwise output, such as through audible cues, haptic signals on a coupled wearable device, etc.

User computing device 412 and the server computing device 415 can be communicatively coupled to one or more storage devices 430 over a network 460. The storage device(s) 430 can be a combination of volatile and non-volatile memory and can be at the same or different physical locations than the computing devices 412, 415. For example, the storage device(s) 430 can include any type of non-transitory computer-readable medium capable of storing information, such as a hard-drive, solid state drive, tape drive, optical storage, memory card, ROM, RAM, DVD, CD-ROM, write-capable, and read-only memories.

The server computing device 415 can include one or more processors 413 and memory 414. Memory 414 can store information accessible by the processor(s) 413, including instructions 421 that can be executed by the processor(s) 413. Memory 414 can also include data 423 that can be retrieved, manipulated, or stored by the processor(s) 413. Memory 414 can further include machine learning model 425. Machine learning model 425 may be trained to identify recommendable music or radio stations based on the user's historical and/or preference data.

Memory 414 can be a type of non-transitory computer-readable medium capable of storing information accessible by the processor(s) 413, such as volatile and non-volatile memory. The processor(s) 413 can include one or more central processing units (CPUs), graphic processing units (GPUs), field-programmable gate arrays (FPGAs), and/or application-specific integrated circuits (ASICs), such as tensor processing units (TPUs).

Instructions 421 can include one or more instructions that when executed by the processor(s) 413, cause the one or more processors to perform actions defined by the instructions. Instructions 421 can be stored in object code format for direct processing by the processor(s) 413, or in other formats including interpretable scripts or collections of independent source code modules that are interpreted on demand or compiled in advance. Instructions 421 can include instructions for implementing processes consistent with aspects of this disclosure. Such processes can be executed using the processor(s) 413, and/or using other processors remotely located from the server computing device 415.

Data 423 can be retrieved, stored, or modified by the processor(s) 413 in accordance with instructions 421. Data 423 can be stored in computer registers, in a relational or non-relational database as a table having a plurality of different fields and records, or as JSON, YAML, proto, or XML documents. Data 423 can also be formatted in a computer-readable format such as, but not limited to, binary values, ASCII, or Unicode. Moreover, data 423 can include information sufficient to identify relevant information, such as numbers, descriptive text, proprietary codes, pointers, references to data stored in other memories, including other network locations, or information that is used by a function to calculate relevant data.

User computing device 412 can also be configured similar to the server computing device 415, with one or more processors 416, memory 417, instructions 418, and data 419. The user computing device 412 can also include a user output 426, and a user input 424. The user input 424 can include any appropriate mechanism or technique for receiving input from a user, such as a keyboard, mouse, mechanical actuators, soft actuators, touchscreens, microphones, and sensors.

Server computing device 415 can be configured to transmit data to the user computing device 412, and the user computing device 412 can be configured to display at least a portion of the received data on a display implemented as part of the user output 426. The user output 426 can also be used for displaying an interface between the user computing device 412 and the server computing device 415. The user output 426 can alternatively or additionally include one or more speakers, transducers, or other audio outputs, a haptic interface, or other tactile feedback that provides non-visual and non-audible information to the platform user of the user computing device 412.

Although FIG. 4 illustrates the processors 413, 416 and the memories 414, 417 as being within the computing devices 415, 412, components described in this specification, including the processors 413, 416 and the memories 414, 417 can include multiple processors and memories that can operate in different physical locations and not within the same computing device. For example, some of the instructions 421, 418 and the data 423, 419 can be stored on a removable SD card and others within a read-only computer chip. Some or all of the instructions and data can be stored in a location physically remote from, yet still accessible by, the processors 413, 416. Similarly, processors 413, 416 can include a collection of processors that can perform concurrent and/or sequential operations. Computing devices 415, 412 can each include one or more internal clocks providing timing information, which can be used for time measurement for operations and programs run by computing devices 415, 412.

The server computing device 415 can be configured to receive requests to process data from the user computing device 412. For example, environment 400 can be part of a computing platform configured to provide a variety of services to users, through various user interfaces and/or APIs exposing the platform services. One or more services may include automatically generating recommendations for similar music or radio station based on monitoring of the user's listening activities.

Devices 412, 415 can be capable of direct and indirect communication over network 460. Devices 412, 415 can set up listening sockets that may accept an initiating connection for sending and receiving information. The network 460 itself can include various configurations and protocols including the Internet, World Wide Web, intranets, virtual private networks, wide area networks, local networks, and private networks using communication protocols proprietary to one or more companies. Network 460 can support a variety of short- and long-range connections. The network 460, in addition, or alternatively, can also support wired connections between devices 412, 415, including over various types of Ethernet connection.

Although a single server computing device 415 and user computing device 412 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

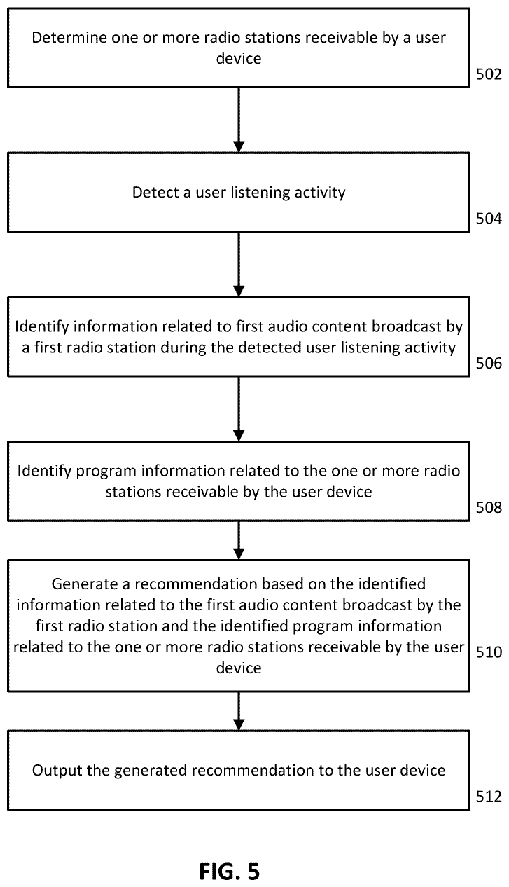

FIG. 5 depicts a flow diagram illustrating a music and radio programming recommendation process. According to block 502, one or more radio stations receivable by a user device are determined. The music and radio programming recommendation system monitors the geographic location of the user device and identify a list of the radio stations receivable by the user device, or receives a list of receivable radio broadcasts from the radio receiver. When the user drives away from one location to another location, the system may keep track of the change in the user device's geographic location and update the list of the radio stations receivable by the user device in real-time or near real-time.

According to block 504, a user's listening activity is detected. The system may monitor the user's listening activity when the user is driving a vehicle and tune the user device such as an in-vehicle radio receiver to one of the determined radio stations receivable by the user device. The system may store the information of the radio station that the user tuned into and identify a radio program or audio content that the user is currently listening to. The system may store timestamp information for the user's listening activity.

According to block 506, information related to the first audio content broadcast by a first radio station is identified. The system may retrieve information related to the audio content that the user is currently listening to. The audio content may include music, songs, radio shows, etc. Such information may include, the genre of the music, associated artist, year when the music was released, etc. The retrieved information may be used to generate recommendations for similar music, such as music by the same artist, similar artists, same genre, or having other attributes comparable to those of the audio content the user listened to.

According to block 508, program information related to the one or more radio stations receivable by the user device is identified. The system may retrieve the program information related to the one or more radio stations receivable by the user device from a remote storage. Such information may be related to radio programs (talk shows, podcasts, news, music programs, etc.) or particular music that each of the one or more radio stations focuses on broadcasting at a particular time on particular days of the week.

According to block 510, a recommendation is generated based on the identified information related to the first audio content broadcast by the first radio station and the identified program information related to the one or more radio stations receivable by the user device. The system may generate a recommendation for similar audio content based on the information related to the first audio content. In other examples, the system may generate a recommendation for a similar radio station based on the information related to the first audio content. The system may also generate a recommendation for a similar radio station based on the information related to the radio station that broadcasts the first audio content.

According to block 512, the generated recommendation is output to the user device. The generated recommendation can be displayed on a screen device included in the user's vehicle or on the display screen of user's portable device such as a laptop, tablet, smartphone or smartwatch. The system may allow the user to accept or decline each of the recommended audio content or radio stations. Any input provided by the user may be stored and analyzed for generating other recommendations in the future.

The techniques described in the present disclosure are beneficial in that they allow for a suggestion of OTA broadcast content based on listening activities associated with other OTA broadcast content. The recommendations can be tailored to the user's current conditions, such as the radio stations receivable by the user at a given time based on the user's location at the given time. In this regard, the recommendation system can efficiently determine recommendations that are most relevant, omitting recommendations for stations that are outside the user's reception area and thereby conserving processing power that would otherwise be used in generating the recommendations and bandwidth that would otherwise be used to transmitting the recommendations to the user.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, cause the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for generating recommendations for receivable over-the-air audio content, the system comprising:
one or more memories; and
one or more processors in communication with the one or more memories, the one or more processors configured to:
determine one or more radio stations receivable by a user device;
detect a user listening activity;
identify information related to first audio content broadcast by a first radio station during the detected user listening activity;
identify program information related to the one or more radio stations receivable by the user device;
generate a recommendation based on the identified information related to the first audio content broadcast by the first radio station and the identified program information related to the one or more radio stations receivable by the user device; and
output the generated recommendation to the user device.

2. The system of claim 1, wherein the user listening activity includes tuning the user device to a first broadcast channel for the first radio station or remaining on the first broadcast channel for a threshold time period.

3. The system of claim 1, wherein the one or more processors are further configured to retrieve metadata of the first audio content from a database and transmit the metadata to the user device, wherein the metadata includes information related to an artist, composer, published date, or genre.

4. The system of claim 1, wherein the one or more processors are further configured to:
determine preference data or historical data for the user based on one or more previous listening activities for the user; and
generate the recommendation based on the determined user's preference data or historical data.

5. The system of claim 1, wherein generating the recommendation comprises generating a recommendation for a second radio station based on the first radio station that the user accessed during the detected user listening activity.

6. The system of claim 1, wherein generating the recommendation comprises generating a recommendation for second audio content broadcast by a second radio station based on program information related to the first radio station that the user accessed during the detected user listening activity.

7. The system of claim 1, wherein generating the recommendation comprises generating a recommendation for a second radio station from the determined one or more radio stations receivable to the user device based on the identified information related to the first audio content broadcast from the first radio station during the detected user listening activity.

8. The system of claim 1, wherein the one or more processors are further configured to receive a request from the user for a customized recommendation using the user device.

9. The system of claim 1, wherein the one or more processors are further configured to receive feedback on the generated recommendation and update the recommendation based on the received feedback using the user device.

10. The system of claim 1, wherein the recommendation is generated specific to a time, day, or week based on available programs of the one or more radio stations receivable by the user device.

11. A method for generating recommendations for receivable over-the-air audio content, the method comprising:
determining one or more radio stations receivable by a user device;
detecting a user listening activity;
identifying information related to first audio content broadcast by a first radio station during the detected user listening activity;
identifying program information related to the one or more radio stations receivable by the user device;
generating a recommendation based on the identified information related to the first audio content broadcast by the first radio station and the identified program information related to the one or more radio stations receivable by the user device; and
outputting the generated recommendation to the user device.

12. The method of claim 11, wherein the user listening activity includes tuning the user device to a first broadcast channel for the first radio station or remaining on the first broadcast channel for a threshold time period.

13. The method of claim 11, further comprising retrieving metadata of the first audio content from a database and transmitting the metadata to the user device, wherein the metadata includes information related to an artist, composer, published date, or genre.

14. The method of claim 11, further comprising determining preference data or historical data for a user based on one or more previous listening activities for the user; and
generating the recommendation based on the determined user's preference data or historical data.

15. The method of claim 11, wherein generating the recommendation comprises generating a recommendation for a second radio station based on the first radio station that the user accessed during the detected user listening activity.

16. The method of claim 11, wherein generating the recommendation comprises generating a recommendation for second audio content broadcast by a second radio station based on program information related to the first radio station that the user accessed during the detected user listening activity.

17. The method of claim 11, wherein generating the recommendation comprises generating a recommendation for a second radio station from the determined one or more radio stations receivable by the user device based on the identified information related to the first audio content broadcast from the first radio station during the detected user listening activity.

18. The method of claim 11, further comprising receiving a request from the user for a customized recommendation using the user device.

19. The method of claim 11, further comprising receiving feedback on the generated recommendation and updating the recommendation based on the received feedback using the user device.

20. A non-transitory computer-readable medium storing instructions executable by one or more processors for performing a method of generating recommendations for receivable over-the-air broadcast content, the method comprising:
determining one or more radio stations receivable by a user device;
detecting a user listening activity;
identifying information related to first audio content broadcast by a first radio station during the detected user listening activity;
identifying program information related to the one or more radio stations receivable by the user device;
generating a recommendation based on the identified information related to the first audio content broadcast by the first radio station and the identified program information related to the one or more radio stations receivable by the user device; and
outputting the generated recommendation to the user device.
